(19) United States
(12) Patent Application Publication
(10) Pub. No.: US 2004/0010330 A1
(43) Pub. Date: Jan. 15, 2004

(54) Speed control of digital audio playback

(76) Inventor: Ling Chen, Livingston, NJ (US)

Correspondence Address: KENYON & KENYON, 1500 K STREET, N.W., SUITE 700, WASHINGTON, DC, 20005, US

(21) Appl. No.: 10/192,547

(22) Filed: Jul. 11, 2002

(51) Int. Cl. G06F 17/00

(52) U.S. Cl. 700/94

(57) ABSTRACT

A method for providing playback speed control of digital audio frames for multiple time slots over multiple of channels includes determining a maximum number of frames that can be processed during each of the time slots for all of the channels. The method further includes calculating a speed change determination for each time slot, the speed change determination specifying a total amount of frames that are processed during the time slots in order to achieve a desired speed change. The method further includes tracking an overload for each of the time slots as each of the channels is processed; and, as each of the channels are processed and for each time slot, generating a number of frames that is substantially equal to the speed determination for each time slot if the overload is substantially less than the determined maximum number of frames, or generating a number of frames as if no desired speed change is requested if the overhead is substantially greater than the determined maximum number of frames.

### FIELD OF THE INVENTION

One embodiment of the present invention is directed to digital audio. More particularly, one embodiment of the present invention is directed to speed control of digital audio playback.

### BACKGROUND INFORMATION

Audio data is increasingly being stored in digital form and played back after being converted back to analog form. For example, most audio music, whether stored on a Compact Disk (“CD”) or in compressed Moving Picture Experts Group, audio layer 3 (“MP3”) form, is digital. Sometimes there is a need to playback audio digital data at a different speed than what was recorded. Many digital answering machines and digital dictaphone systems allow for playback of digital messages at variable speeds.

Most audio digital data is transmitted and processed in the unit of a frame. Each frame represents the audio data for a fixed time period (typically about 5-30 milliseconds) called a time slot. At some requested playback speeds, fractional frames per time slot may be required. However, many systems have components such as decoders that can only process whole frames.

In addition, most audio playback systems of telecommunication equipment include a processor that may handle many channels of audio playback at one time. The capacity or the processing power of a processor is often measured by Million of Instructions per Second (“MIPS”). It is desirable to control all the channels of an audio playback system so the peak MIPS required during a particular time slot does not exceed the available total MIPS of the processor.

Based on the foregoing, there is a need for a variable speed audio playback system that has minimal latency and buffer size and that has a peak MIPS that does not exceed the maximum average MIPS of its processor.

### BRIEF DESCRIPTION OF THE DRAWINGS

FIG. 1 is a block diagram of a digital audio playback system having speed control in accordance with one embodiment of the present invention.

FIG. 2 is a functional block diagram of the digital audio playback system of FIG. 1 in accordance with one embodiment of the present invention.

FIG. 3 is a flow diagram of the functionality performed by the digital audio playback system in accordance with one embodiment of the present invention.

### DETAILED DESCRIPTION

One embodiment of the present invention is a digital audio system that provides efficient variable speed playback by distributing processor load over both channels and time slots. This avoids high peak MIPS of the system processor without the penalties of latency and buffer size.

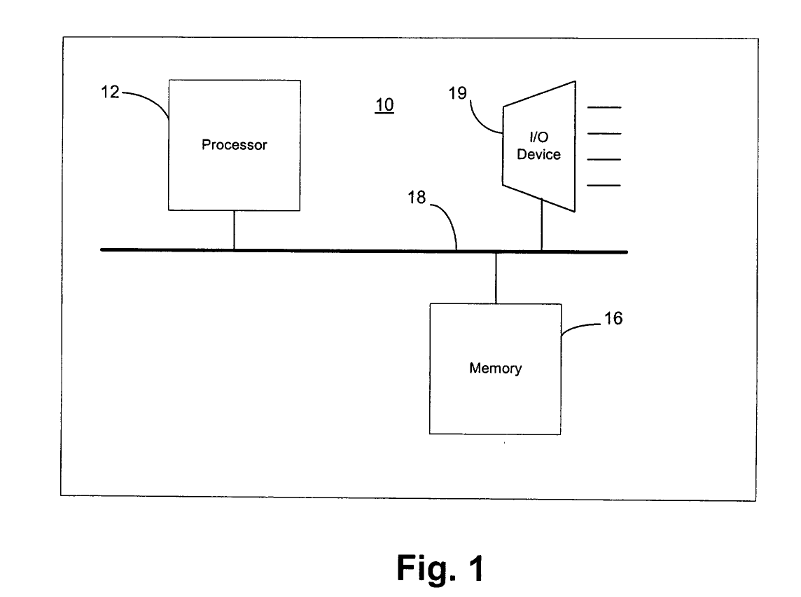

FIG. 1 is a block diagram of a digital audio playback system 10 having speed control in accordance with one embodiment of the present invention. System 10 includes a processor 12 and a memory 16 coupled to a bus 18. Processor 12 can be any type of processor. In one embodiment, processor 12 is the Pentium 4 processor from Intel Corp. Memory 16 stores software instructions that can be executed by processor 12 to perform some or all of the functionality of one embodiment of the present invention. System 10 further includes an input/output (“I/O”) device 19 that receives recorded (compressed) audio data, and sends recovered audio signal data to an external audio device such as a speaker.

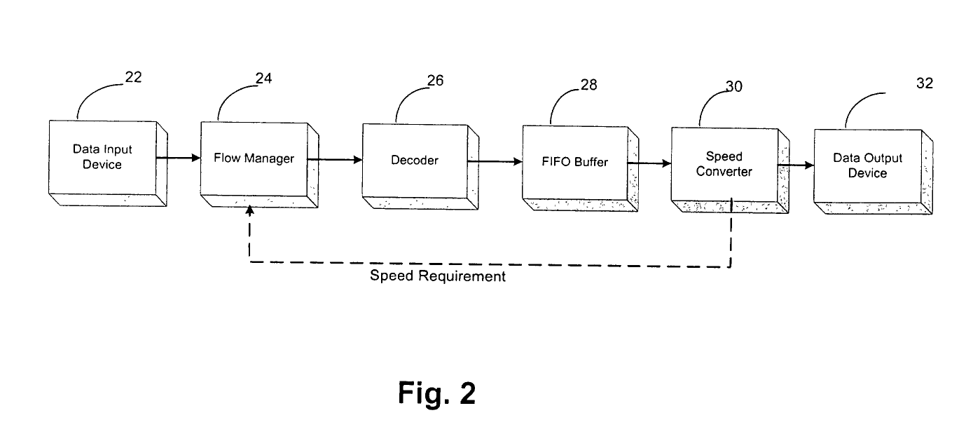

FIG. 2 is a functional block diagram of digital audio playback system 10 of FIG. 1 in accordance with one embodiment of the present invention. The functionality includes a data input device 22 that receives the audio digital data to be played back. In one embodiment, data input device 22 is implemented by memory 16 of FIG. 1, or by any other type of memory device, including a disk drive.

Coupled to data input device 22 is a flow manager 24. Flow manager 24 reads audio digital data from data input device 22 in the form of frames, and supplies the frames at a variable rate depending on the playback speed desired. Other functional components include a decoder 26 that decodes data received from flow manager 24 and a buffer 28 to temporarily store the frames. In one embodiment, buffer 28 is a First In/First Out (“FIFO”) buffer. Further included is a speed converter 30 that converts received frames of variable speed into a fixed rate so they can be transferred by a data output device 32.

In one embodiment, the functionality of flow manager 24, decoder 26 and speed converter 30 are implemented by processor 12 of FIG. 1, and the functionality of FIFO buffer 28 is implemented by memory 16 and processor 12 of FIG. 1. However, the functionality of all blocks of FIG. 2 may be implemented by any combination of hardware and software, and by a single processor or by multiple specialized processors or other hardware.

In one embodiment, up to the stage of decoder 26, the digital audio data is transmitted and processed in the unit of a frame. Each frame represents the audio digital data for one time slot. The input frames of decoder 26 are encoded digital and can have variable frame size. The output of decoder 26 are the real samples of digital data with the original playback speed and with its frame size fixed as SO samples per frame.

After storing the digital data in buffer 28, speed converter 30 receives the input data at a higher or lower rate of S₀+ΔS samples per time slot and then converts it to the original fixed rate of S₀ samples per time slot. The ratio of ΔS to S₀ (i.e., D=ΔS/S₀×100%, typically −50%≦D≦+50% for audio players) reflects the speed changes required by the playback system.

If the audio digital data is played back at original speed (i.e., D=0), flow manager 24 supplies the data frames to decoder 26 at the rate of 1 frame per time slot. When a particular speed change value (i.e., D≠0 and −0.5≦D≦+0.5) is required, speed converter 30 will require flow manager 24 to supply the frames at the rate of 1+D frames per time slot (here 1+D is a fractional number). However, in some embodiments, supplying and processing fractional frames per time slot may not be possible. In these embodiments, flow manager 24 can only achieve such a fractional frame rate in long time average by supplying the frames at the variable rates of 0, 1 or 2 frames per time slot.

Because of the variable frame rate from flow manager 24 and decoder 26, frames are stored in buffer 28, which introduces latency and uses memory resource. Therefore, in one embodiment flow manager 24 achieves the average frame rate of 1+D frames per time slot with minimal latency and buffer size.

The functional components shown in FIG. 2 represent a single channel of a playback system in accordance with one embodiment of the present invention. However, a playback system typically includes multiple channels, all operated by a single processor with a fixed MIPS capacity such as processor 12 of FIG. 1.

If the decoding of one frame requires MO MIPS, then the speed change results in the MIPS requirement of (1+D)×M₀, if decoder 26 can process fractional frames. If one processor handles N channels, the total MIPS requirement is M_{T}=(1+D)×M₀×N=(1+D)×M_{N} (where M_{N}=M₀×N is the total MIPS of decoding without speed changes).

However, because in one embodiment decoder 26 can only process the data at the variable rates of 0, 1 or 2 frames per time slot, the total MIPS requirement also varies between 0 to 2×M_{N}, although the long time average is still M_{T}. The peak MIPS requirement can be as high as Mₚ=2×M_{N} which may be significantly higher than the average. The higher peak MIPS will cause the inefficient usage of the processor capacity and the loss of channel density. Therefore, flow manager 24 in one embodiment of the present invention controls the total MIPS of all the channels so that the peak MIPS does not exceed the maximum average MIPS, corresponding to the maximum speed change requirement.

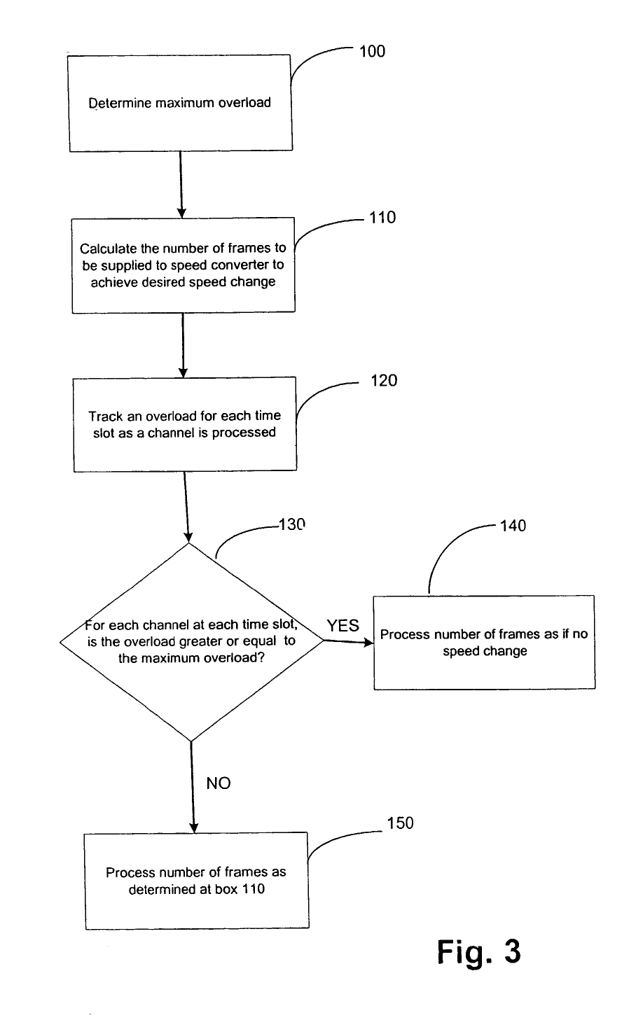

FIG. 3 is a flow diagram of the functionality performed by system 10 in accordance with one embodiment of the present invention. In one embodiment, the functionality is implemented by software stored in memory and executed by a processor. In other embodiments, the functionality can be performed by hardware, or any combination of hardware and software. In general, the functionality shown in FIG. 3 is executed by flow manager 24 of FIG. 2 when determining the amount of frames to process per time period and per channel in order to achieve a playback speed requested by speed converter 30.

At box 100, the maximum number of frames that can be processed at each time slot for all of the channels, referred to as the maximum allowed “overload”, is determined. In one embodiment, the maximum allowed overload ΔFₘₐₓ due to the speed control, typically in terms of the number of frames processed in any time slot for all the channels totally, is determined at box 100.

At box 110, the number of frames to be processed and supplied to speed converter 30 per time slot in order to achieve a desired speed change requested by speed converter 30 is determined. The number of frames can be called the speed change determination for each time slot. In one embodiment, a formula S_{d}(t) can be derived that keeps tracking the difference between the amount of supplied data to speed converter 30 and that of consumed data by speed converter 30 over the time t for each channel. From S_{d}(t), another formula C(t) can be derived that determines how many frames should be supplied to speed converter 30 in order to achieve the required fractional frame rate.

At box 120, for each time slot, the overload is tracked as a channel is processed to insure that the peak MIPS for the processor is not exceeded. The overload ΔF(n) is tracked when the channel n is processed. The proper amount is added to ΔF(n) if the channel processes more frames than the normal case (i.e., without speed changes) and the proper amount is subtracted from AF(n) if less frame is processed. ΔF(n) is reset to 0 at the beginning of each time slot. That is, ΔF(0)=0 if the channels are processed in the sequence order of 0, 1, 2, ...

At decision point 130, for each channel and at each time slot, it is determined whether the tracked overload is greater than or less than the maximum overload determined at box 100. If the tracked overload is greater and D>0 (i.e., the current channel is doing speed up), then at box 140 the number of frames to be processed is determined as if no speed change was requested by speed converter 30, thereby preventing a peak MIPS situation. However, if the tracked overload is less than the maximum, then at box 150 the number of frames to be processed is the number determined at box 110 by, for example, the defined formula. Decision point 130, and boxes 140 and 150 can be summarized as follows:

Assuming the channels are processed in the sequence order of 0,1, 2,. For the channel n+1 at the time slot t, the number of frames to be processed is determined as:

$$f ( n + 1 , t ) = \{ \begin{matrix}normal ( as if no speed change ) , & if Δ F ( t ) \geq Δ {F}_{max} and D > 0 \\ determined by C ( t ) , & otherwise \end{matrix}$$

In one embodiment of the present invention, a specific algorithm is applied that guarantees the average frame rate of 1+D frames per time slot as required by speed converter 30 and the peak MIPS limitation of Mₚ≦Mₘₐₓ (where Mₘₐₓ≈(1+Dₘₐₓ)×M_{N}=1.5×M_{N}). As a result, the latency and FIFO buffer 28 size required by the algorithm are relatively small and are practically acceptable.

In general, the algorithm distributes the processor load among both the channels and the time slots so that the high peak MIPS can be avoided simultaneously while managing the frame rate. The algorithm that jointly manages the frame rate and the MIPS in accordance with one embodiment of the present invention is described below.

The symbols of constants and variables used in the algorithm are as follows:

| | |
|---|---|
| t: | the index of the time slot (t = 0, 1, 2, . . . ). |
| N: | the total number of channels. N is typical in the range between |
| | 10˜200. |
| f(t): | the number of frames decoded in a channels at time slot t. n(t) = |
| | 0, 1, or 2. |
| ΔF(t): | the total number of the extra frames decoded in all the channels |
| | due to the speed changes at time slot t. ΔF(t) = 0 if no speed |
| | change (i.e., all the channels decode one frame per time slot). |
| ΔFₘₐₓ: | the maximum value of ΔF(t) allowed in any time slot in order to |
| | limit peak MIPS. |
| S₀: | the frame size of the outputs of decoder 26 and speed converter |
| | 30 (in samples). |
| S₁: | the frame size of speed converter 30 input (in samples). |
| L: | an integer number between 5˜10. It is a tunable algorithm |
| | parameter. |
| n_{L}(t): | the total number of frames to be decoded in a channel during the |
| | period of L time slots. |
| S_{d}(t): | the cumulated difference between the number of samples |
| | supplied by decoder 26 and that consumed by speed converter 30 |
| | in a channel at time slot t. |
| k: | the circular time slot index (k = 0, 1, 2, . . . , L − 1). |

Note:
N, ΔF(t), ΔFₘₐₓ, S₀ and L are processor-wide constants or variable. All others are channel-specific variables, i.e., each channel has to maintain its own copies of those variables.

The purpose of the algorithm is to calculate the number of frames f(t) that flow manager 24 must supply to decoder 26 at time slot t for each channel. The algorithm includes the following functions:

(1) Initial settings:

ΔFₘₐₓ=[(N+1)/2]

t=0

k=0

S_{d}(0) =0

ΔF(0)=0

Sₗ is determined by speed converter 30 (0.5×S₀≦Sₗ≦1.5×S₀)

n_{L}(0)=[(Sₗ×L+S₀−1)/S₀]

$$f ( - 1 ) = \{ \begin{matrix}0 , & if {n}_{L} ( 0 ) < L \\ 1 , & otherwise \end{matrix}$$

where [•] means truncation to the integer.

(2) Calculate f(t) by:

$$f ( t ) = \{ \begin{matrix}1 , & if f ( t - 1 ) \neq 1 or {n}_{L} ( t ) = L - k or Δ F ( t ) \geq Δ {F}_{max} \\ 0 , & else if {n}_{L} ( t ) < L - k \\ 2 , & else \end{matrix}$$

(3) Update the variables:

t=t+1

n_{L}(t)=n_{L}(t−1)−f(t−1)

ΔF(t)=ΔF(t)+f(t−1)−1

S_{d}(t)=S_{d}(t−1)+f(t−1)×S₀−Sₗ

k=t mod L

(4) Reset variable nL(t) once every L time slots:

If k=0 then

n_{L}(t)=[(Sₗ×L−S_{d}(t)+S₀−1)/S₀]

(5) Reset ΔF(t) to 0 if functions (2)˜(4) have been performed for all the channels at this time slot.

(6) Go back to function (2) for the next time slot.

As described, one embodiment of the present invention is a digital audio system that provides efficient variable speed playback by distributing processor load over both channels and time slots. This avoids high peak MIPS of the system processor without the penalties of latency and buffer size. A specific algorithm is disclosed, but any method that jointly manages the frame rate and the MIPS can be used.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method of providing playback speed control of digital audio frames for a plurality of time slots over a plurality of channels, said method comprising:
determining a maximum number of frames that can be processed during each of the time slots for all of the channels;
calculating a speed change determination for each time slot, the speed change determination specifying a total amount of frames that are processed during a first time slot in order to achieve a desired speed change;
tracking an overload for each of the time slots as each of the channels is processed; and
as each of the channels is processed and for each time slot, generating a first number of frames substantially equal to the speed change determination for each time slot if the tracked overload is substantially less than the determined maximum number of frames, or generating a second number of frames as if no desired speed change is requested if the tracked overload is substantially greater than the determined maximum number of frames.

2. The method of claim 1, wherein the desired speed change is a change in playback speed of the digital audio frames from a speed that the digital audio frames were originally generated.

3. The method of claim 1, wherein calculating the speed change determination comprises tracking a difference between an amount of frames supplied to a speed converter to an amount of frames consumed by the speed converter.

4. The method of claim 1, wherein the maximum number of frames is based on a peak MIPS of a processor.

5. The method of claim 1, wherein the first number of frames and the second number of frames are whole numbers.

6. The method of claim 1, wherein the plurality of channels are processed by a processor.

7. A method of processing digital audio frames over a plurality of time slots over a plurality of channels, said method comprising:
determining a maximum overload that can be processed during each of the time slots;
receiving a desired speed change;
calculating a speed change determination for each time slot, the speed change determination specifying a total amount of frames that are processed during a first time slot in order to achieve the desired speed change;
tracking an overload for each of the time slots as each of the channels is processed; and
as each of the channels are processed and for each time slot, generating a first number of frames substantially equal to the speed change determination for each time slot if the tracked overload is substantially less than the determined maximum overload, or generating a second number of frames as if no desired speed change is requested if the tracked overload is substantially greater than the determined maximum overload.

8. The method of claim 7, wherein the desired speed change is a change in playback speed of the digital audio frames from a speed that the digital audio frames were originally generated.

9. The method of claim 7, wherein calculating the speed change determination comprises tracking a difference between an amount of frames supplied to a speed converter to an amount of frames consumed by the speed converter.

10. The method of claim 7, wherein the maximum overload is based on a peak MIPS of a processor.

11. The method of claim 7, wherein the first number of frames and the second number of frames are whole numbers.

12. The method of claim 7, wherein the plurality of channels are processed by a processor.

13. An audio digital data playback system comprising:
a flow manager;
a speed converter coupled to said flow manager;
wherein said speed converter determines a desired playback speed and said flow manager, in response:
determines a maximum overload that can be processed during each of a plurality of time slots;
calculates a speed change determination for each time slot, the speed change determination specifying a total amount of frames that are processed during a first time slot in order to achieve the desired playback speed;
tracks an overload for each of the time slots as each of the channels is processed; and
as each of the channels are processed and for each time slot, generates a first number of frames substantially equal to the speed determination for each time slot if the overload is substantially less than the determined maximum overload, or generates a second number of frames as if no desired speed change is requested if the overload is substantially greater than the determined maximum overload.

14. The audio digital data playback system of claim 13, further comprising: a buffer coupled to said flow manager for storing the first number of frames and the second number of frames.

15. The audio digital data playback system of claim 14, wherein said buffer is a First In/First Out buffer.

16. The audio digital data playback system of claim 13, further comprising a decoder coupled to said flow manager.

17. The audio digital data playback system of claim 13, wherein said speed converter converts received frames into an original fixed rate.

18. A computer readable medium having stored thereon instructions that, when executed by a processor, cause the processor to provide playback speed control of digital audio frames for a plurality of time slots over a plurality of channels by:
determining a maximum number of frames that can be processed during each of the time slots for all of the channels;
calculating a speed change determination for each time slot, the speed change determination specifying a total amount of frames that are processed during a first time slot in order to achieve a desired speed change;
tracking an overload for each of the time slots as each of the channels is processed; and
as each of the channels are processed and for each time slot, generating a first number of frames substantially equal to the speed determination for each time slot if the tracked overload is substantially less than the determined maximum number of frames, or generating a second number of frames as if no desired speed change is requested if the tracked overhead is substantially greater than the determined maximum number of frames.

19. The computer readable medium of claim 18, wherein the desired speed change is a change in playback speed of the digital audio frames from a speed that the digital audio frames were originally generated.

20. The computer readable medium of claim 18, wherein calculating the speed change determination comprises tracking a difference between an amount of frames supplied to said speed converter to an amount of frames consumed by said speed converter.

21. The computer readable medium of claim 18, wherein the first number of frames and the second number of frames are whole numbers.
